(19) United States
(12) Patent Application Publication
(10) Pub. No.: US 2026/0178564 A1
(43) Pub. Date: Jun. 25, 2026

(54) SYSTEM AND METHOD FOR MANAGING BLOCKCHAIN DATA INDEX AND VERIFYING QUERY PROCESSING RESULT

(71) Applicant: ELECTRONICS AND TELECOMMUNICATIONS RESEARCH INSTITUTE, Daejeon (KR)

(72) Inventor: Dong Myung Sul, Daejeon (KR)

(21) Appl. No.: 19/248,746

(22) Filed: Jun. 25, 2025

(30) Foreign Application Priority Data
Oct. 23, 2024 (KR) 10-2024-0145501

(51) Int. Cl. G06F 16/23; G06F 16/22

(52) U.S. Cl. CPC G06F 16/2365; G06F 16/2228; G06F 16/2379

(57) ABSTRACT

Provided are a system and method for managing a blockchain data index and verifying a query processing result. The method includes collecting, by a system for managing a blockchain data index and verifying a query processing result, block data in a predetermined range from a blockchain network, indexing, by the system, the block data to generate an index, generating, by the system, an index database (DB), which is a data structure for verifying integrity of the index, based on the index, and transmitting, by the system, the index DB to the blockchain network to request verification.

### CROSS-REFERENCE TO RELATED APPLICATION

This application claims priority under 35 U.S.C. § 119 to Korean Patent Application No. 10-2024-0145501, filed on Oct. 23, 2024, in the Korean Intellectual Property Office, the disclosure of which is incorporated herein by reference in its entirety.

### BACKGROUND

### 1. Field of the Invention

The present invention relates to a system and method for generating an external index for blockchain data and verifying a query processing result using the index on a blockchain platform.

### 2. Description of Related Art

Blockchain technology is widely used as a distributed database system that ensures data integrity and transparency. The amount of data generated in a blockchain network continuously increases over time, and efficiently managing and verifying the data has emerged as an important issue. Existing blockchain indexing data management methods have issues with inefficiency in storage space and overhead in the verification process, and the present invention proposes a new method to solve these issues.

Hereinafter, the main issues that may occur when searching for blockchain data are described.

A blockchain is a distributed database system that continuously adds new data and grows. The amount of data increases exponentially over time, which may decrease the search speed. Since the blockchain connects and stores all transactions and blocks in a chain form, the more data there is, the longer it may take to search for specific data. This may be a big limitation, especially when real-time search is required.

The blockchain has a distributed network structure, in which data is distributed and stored throughout the entire network. Accordingly, data search and access may require more time. Unlike a centralized database, the blockchain may require access to a plurality of nodes in a network when searching for data. The speed of data search may be significantly affected by the state of the network and the response speed of the nodes.

Blockchain data is stored in units of transactions and does not have an efficient indexing structure as in the existing databases. While the databases use various indexing techniques to rapidly search for data, it is difficult to use the indexing techniques in blockchains. As a result, when searching for data, all blocks may need to be searched sequentially, which significantly reduces search efficiency.

Blockchains ensure the integrity of data, but it is required to perform a process of verifying that data has not been falsified during the search process. In other words, when searching for data in blockchains, it is required to verify that the data has not been falsified. The process requires additional computation, which may reduce the search speed. In particular, the verification process is more complex and time-consuming for large-scale data.

In blockchains, traditional database query languages, such as SQL, may not be used. Since traditional database query languages cannot be used for data search in blockchains, a separate method needs to be used to search for data. This increases the training cost for developers and makes it difficult to perform efficient search.

Data stored in blockchains may be unstructured data. Data stored in blockchains may be unstructured data in various formats, making it difficult to efficiently search for and analyze the data. This poses a significant limitation, especially for searches for data analysis or business intelligence uses.

Due to the nature of distributed networks, synchronization issues between nodes and network latency may occur. In a blockchain network, all nodes need to maintain the same data, but due to network latency or synchronization issues between nodes, consistency may not be ensured when searching for data. This becomes problematic, especially when searching for the latest data.

Data stored on blockchains may be public data that anyone may access, which may cause privacy and security issues. Since blockchain data is publicly accessible, additional security measures are required to protect data containing personal information when the data is searched for. This may complicate the search process and incur additional costs.

Blockchain data may have complex data structures, and searching for blockchain data may be time-consuming. Blockchain data may contain various transactions and smart contracts, and searching for and analyzing such complex data structures is a difficult task. This is especially problematic when searching for data that satisfies specific conditions.

The above-described limitations may reduce the efficiency of searching for blockchain data, and various technical approaches are needed to resolve the limitations.

Among the methods to resolve the above limitation, one approach is to use a limited range of searches that may be provided by the blockchain platform or to replicate blockchain data to an external database and use the search method provided by the database system. First, when using a search using APIs provided by the blockchain network, query process is performed only on the values (a block number, a transaction ID) used in the blockchain, and in order to search for other user-entered data, blocks managed by the blockchain network need to be sequentially read from the beginning and compared, which reduces search efficiency.

On the other hand, when blockchain data is replicated to an external database to provide a data search service, several issues arise. External databases are likely to use a centralized data storage. This contradicts decentralization, which is one of the core values of blockchain. In addition, a centralized data storage has potential risks that data may be changed or manipulated. External databases do not ensure the high security of the blockchain. Blockchain is composed of a decentralized network and uses encryption technologies and consensus algorithms to ensure data integrity and security. However, since external databases do not use the security assurance method, security issues, such as data falsification, may occur.

To resolve the blockchain data search performance issues, there is a method of indexing blockchain data for searches.

Blockchain data indexing technology is technology used for efficient search and inquiry in blockchain. Since blockchain is a massive distributed database, it is difficult to rapidly search for and retrieve all transactions. To resolve these limitations, blockchain data indexing technology provides a method of indexing transaction information and facilitating search.

### SUMMARY OF THE INVENTION

The present invention is directed to providing a system and method for indexing blockchain data, generating a validation database for a corresponding index, storing the database in a blockchain, and performing a verification task on the corresponding index during the storing of the validation database in the blockchain.

The present invention is directed to providing a system and method for verifying a query processing result using the index using the validation database stored in the blockchain, thereby checking for falsification and omission in query processing result data.

The technical objectives of the present invention are not limited to the above, and other objectives may become apparent to those of ordinary skill in the art based on the following description.

According to an aspect of the present invention, there is provided a method of managing a blockchain data index and verifying a query processing result, which includes collecting block data in a predetermined range from a blockchain network, indexing the block data to generate an index, generating an index database (DB) for verifying the index, based on the index, and transmitting, by the system, the index DB to the blockchain network to request verification.

The method may include generating, by the blockchain network, a validation DB for verifying the index DB based on the index DB, and verifying, by the blockchain network, the index DB by comparing the index DB with the validation DB.

The method may further include storing, by the blockchain network, the index DB in a verification blockchain when no abnormality is found as a result of the verifying of the index DB.

The verifying of the index DB may include comparing, by the blockchain network, a data count for individual key values included in the index DB with a data count for individual key values included in the validation DB and verifying the index DB.

The method may further include transmitting, by the blockchain network, a result of the verifying of the index DB and a storage result of the index DB to the system when no abnormality is found as a result of the verifying of the index DB.

The method may further include transmitting, by the blockchain network, a result of the verifying of the index DB to the system without storing the index DB in a verification block chain when an abnormality is found as a result of the verifying of the index DB.

The index DB may include information including a range of block numbers corresponding to the predetermined range, a name of an indexer managing the index within the system, a key value included in the index, and a pair of the key value and a data count for the key value.

The method may further include receiving, by the system, a query command from a user application, parsing, by the system, the query command and generating a search condition based on a parsing result for the query command, generating, by the system, a transaction list corresponding to the search condition and a query DB which is a data structure for verifying the transaction list, and transmitting, by the system, the transaction list and the query DB to the blockchain network to request transaction data corresponding to the query command.

The method may further include comparing, by the blockchain network, the query DB with the index DB to verify the query DB.

The method may further include, when it is determined, as a result of the verifying of the query DB by the blockchain network, that there is no abnormality, receiving, by the system, the transaction data corresponding to the transaction list from the blockchain network.

The verifying of the query DB may include comparing, by the blockchain network, a data count for individual key values included in the query DB with a data count for individual key values included in the index DB and verifying the query DB.

The verifying of the query DB may include comparing, by the blockchain network, a data count for individual key values included in the query DB with a data count for individual key values included in the index DB, when the data counts for the individual key values match each other, extracting the transaction data corresponding to the transaction list from the data blockchain, and determining whether the number of transactions included in the query DB and the number of transactions of the transaction data extracted from the data blockchain match each other and verifying the query DB.

According to an aspect of the present invention, there is provided a method of managing a blockchain data index and verifying a query processing result, which includes receiving, by a system for managing a blockchain data index and verifying a query processing result, a query command from a user application, parsing, by the system, the query command and generating a search condition based on a parsing result for the query command, generating, by the system, a transaction list corresponding to the search condition and a query DB which is a data structure for verifying the transaction list, and transmitting, by the system, the transaction list and the query DB to a blockchain network to request transaction data corresponding to the query command.

The method may further include comparing, by the blockchain network, the query DB with an index DB that includes information about an index managed by the system and verifying the query DB.

The method may further include, when it is determined, as a result of the verifying of the query DB by the blockchain network, that there is no abnormality, receiving, by the system, the transaction data corresponding to the transaction list from the blockchain network.

The verifying of the query DB may include comparing, by the blockchain network, a data count for individual key values included in the query DB with a data count for individual key values included in the index DB to verify the query DB.

The verifying of the query DB may include comparing, by the blockchain network, a data count for individual key values included in the query DB with a data count for individual key values included in the index DB, when the data counts for the individual key values match each other, extracting the transaction data corresponding to the transaction list from the data blockchain, and determining whether the number of transactions included in the query DB and the number of transactions of the transaction data extracted from the data blockchain match each other and verifying the query DB.

According to an aspect of the present invention, there is provided a system for managing a blockchain data index and verifying a query processing result, which includes a memory storing computer-readable instructions, and at least one processor configured to execute the instructions, wherein the at least one processor executes the instructions to collect block data in a predetermined range from a blockchain network, index the block data to generate an index, generate an index DB which is a data structure for verifying integrity of the index, based on the index, and transmit the index DB to the blockchain network.

The at least one processor may be configured to, upon receiving a query command from a user application, parse the query command and generate a search condition based on a parsing result for the query command; generate a transaction list corresponding to the search condition and a query DB which is a data structure for verifying the transaction list; and transmit the transaction list and the query DB to the blockchain network to request transaction data corresponding to the query command.

The at least one processor may be configured to allow the blockchain network to verify the query DB based on the query DB and the index DB, and when it is determined, as a result of the verifying of the query DB, that there is no abnormality, receive the transaction data from the blockchain network.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating the configuration of a system for managing a blockchain data index and verifying a query processing result according to an embodiment of the present invention;

FIG. 2 is a conceptual diagram illustrating blockchain data search using an indexer;

FIGS. 3 and 4 are flowcharts for describing a method of generating an index database (DB) and performing verification according to an embodiment of the present invention;

FIG. 5 is an exemplary diagram of an index DB;

FIG. 6 is an exemplary diagram of a validation DB;

FIGS. 7 and 8 are flowcharts for describing a method of verifying blockchain data query processing results according to an embodiment of the present invention;

FIG. 9 is an exemplary diagram of a query DB; and

FIG. 10 is a block diagram illustrating a computer system for implementing a method of generating and verifying an index DB and a method of verifying blockchain data query processing results according to an embodiment of the present invention.

### DETAILED DESCRIPTION OF EXEMPLARY EMBODIMENTS

The advantages and features of the present invention and ways of achieving them will become readily apparent with reference to the detailed description of the following embodiments in conjunction with the accompanying drawings. However, the present invention is not limited to such embodiments and may be embodied in various forms. The embodiments to be described below are provided only to complete the disclosure of the present invention and assist those of ordinary skill in the art in fully understanding the scope of the present invention, and the scope of the present invention is defined only by the appended claims. Terms used herein are used to aid in the description and understanding of the embodiments and are not intended to limit the scope and spirit of the present invention. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when a first element is referred to as being “connected” or “coupled” to a second element, the first element can be directly connected or coupled to the second element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In this specification, “indexing” refers to a process of generating an index by extracting characteristic parts (keys) of specific data to rapidly search for the data.

In the description of the present invention, when it is determined that a detailed description of related technology may unnecessarily obscure the gist of the present invention, the detailed description will be omitted.

Hereinafter, embodiments of the present invention will be described with reference to the accompanying drawings in detail. For better understanding of the present invention, the same reference numerals are used to refer to the same elements through the description of the drawings.

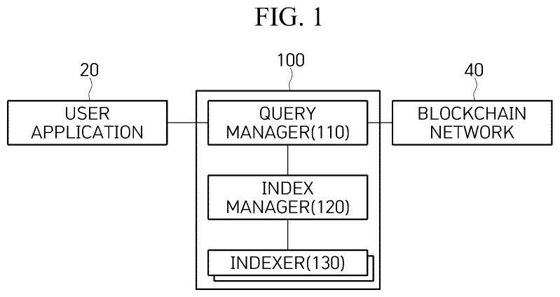

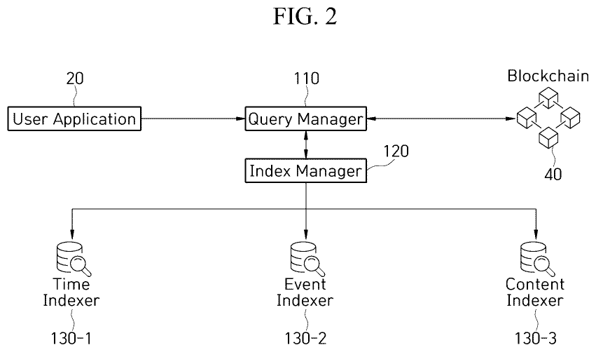

FIG. 1 is a block diagram illustrating the configuration of a system for managing a blockchain data index and verifying a query processing result according to an embodiment of the present invention, and FIG. 2 is a conceptual diagram illustrating blockchain data search using an indexer.

A system 100 for managing a blockchain data index and verifying a query (hereinafter abbreviated as “a system”) according to the embodiment of the present invention includes a query manager 110, an index manager 120, and an indexer 130.

The indexer 130 may be present as a plurality of indexers. When there are a plurality of indexers 130, each indexer is referred to by a different reference symbol, such as 130-1, 130-2, . . . , and 130-n (see FIG. 2).

The system 100 may be implemented in the form of a computer system. All components of the system 100 may be implemented on one server. For example, the query manager 110, the index manager 120, and the indexer 130 may each be implemented as software modules on a single server.

In addition, each component of the system 100 may be implemented on a separate server. For example, a plurality of indexers 130-1, 130-2, . . . , and 130-n may each be implemented on a separate server. In this case, each indexer 130 may be referred to as an “index server.”

The system 100 shown in FIG. 1 is based on an embodiment, and components of the system 100 according to the present invention are not limited to those shown in FIG. 1, and some components may be added, changed, or omitted as needed.

The system 100 is connected to a user application 20 and a blockchain network 40. The blockchain network 40 includes a plurality of nodes 41 and 42.

The query manager 110 receives a data storage request or a data query (which may be referred to as a “query for blockchain data” or a “data search request”) from the user application 20 and processes the data storage request or the data query.

The query manager 110, upon receiving a query for blockchain data from the user application 20, requests required information from the blockchain network 40 and the index manager 120 to process the query. The index manager 120 generates and manages the indexer 130 according to a request of the query manager 110 during initial configuration, and processes data indexing and search requests. The index manager 120 generates and manages the indexer 130 by distinguishing the indexer 130 according to the data type.

Hereinafter, the overall process of the system 100 according to an embodiment of the present invention processing blockchain data using the query manager 110 and the index manager 120 is described.

When a transaction occurs in the user application 20, a process of storing data regarding the corresponding transaction in the blockchain network 40 and the index is as follows. The user application 20 requests the query manager 110 to store generated original data. The query manager 110 converts the corresponding original data into a transaction structure and transmits the converted original data to the blockchain network 40 for the converted original data to be stored. The blockchain network 40 returns a block number and a transaction ID, which are generated by storing the original data converted into the transaction structure, to the query manager 110 as result values. Since the query manager 110 shares information about types of generated indexes and index-specific data storage structure with the index manager 120, the query manager 110 may analyze the block number and transaction ID received from the blockchain network 40 and classify information to be stored in the index. The query manager 110 extracts the block number and the transaction ID, in which the original data is stored, and index key (data) from the blockchain network 40, and transmits the extracted information to the index manager 120 along with an indexer ID of the indexer 130 in which the information is to be stored. The index manager 120 transmits the information received from the query manager 110 to the indexer 130, and the indexer 130 indexes the received information to generate an index, and stores the index in the form of a file in an interplanetary file system (IPFS) 140. For reference, IPFS refers to a decentralized distributed protocol or a distributed storage system that operates according to the protocol.

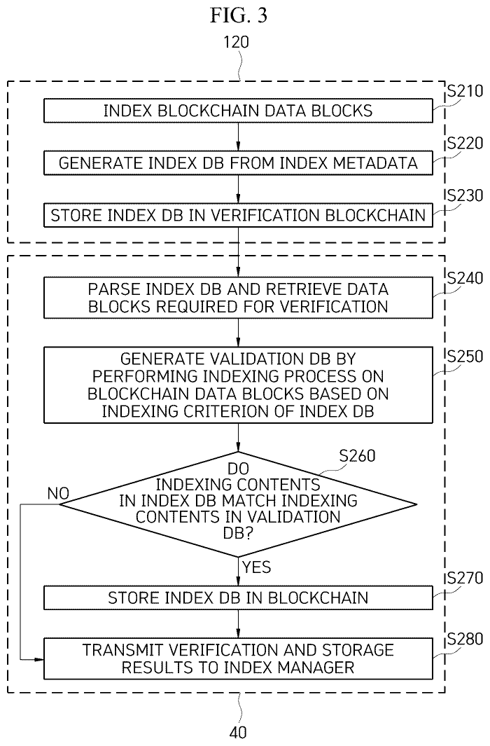

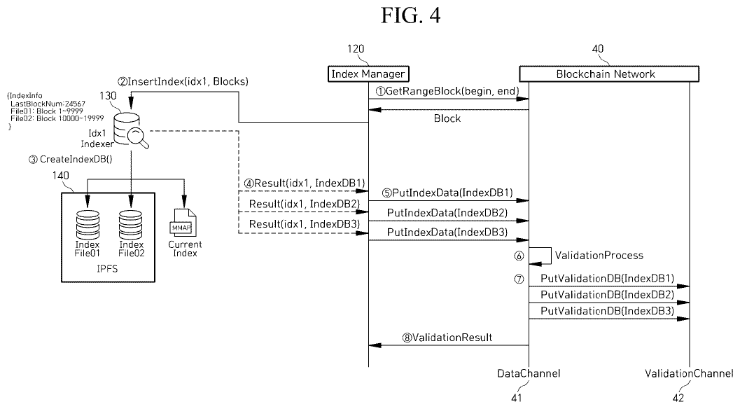

FIGS. 3 and 4 are flowcharts for describing a method of generating and verifying an index DB used to verify an index of blockchain data (hereinafter referred to as “an index DB generation and verification method”) according to an embodiment of the present invention.

The index DB generation and verification method includes operations S210 to S280. The index DB generation and verification method shown in FIGS. 3 and 4 is based on an embodiment, and operations of the index DB generation and verification method according to the present invention are not limited to the embodiment shown in FIGS. 3 and 4, and some operations may be added, changed, or omitted as needed.

The index DB generation and verification method is a method of efficiently indexing blockchain data blocks, generating an index DB reflecting metadata about a blockchain data index (hereinafter referred to as “index”), and verifying the generated index DB and storing the verified index DB in a blockchain.

Operation S210 is an operation of indexing.

The index manager 120 requests block data in a predetermined range from the blockchain network 40. Specifically, the index manager 120 extracts and retrieves all blocks from a starting block to a last block corresponding to the predetermined range from a data blockchain 41 (which may be referred to as a data channel) through the blockchain network 40. Then, the index manager 120 transmits the extracted block data to the indexer 130, and the indexer 130 indexes the block data to generate an index.

Operation S220 is an operation of generating an index DB.

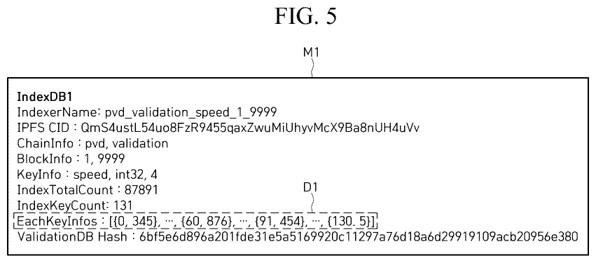

The index manager 120 generates metadata for the index and generates an index DB based on the metadata (see FIG. 5). The index DB is a data structure for verifying the integrity of the index.

Operation S230 is an operation of transmitting the index DB to the blockchain.

The index manager 120 transmits the index DB to the blockchain network 40.

Operation S240 is an operation of extracting blockchain data blocks required for verification of the index DB.

The blockchain network 40 extracts data blocks required for verification of the index DB from the data blockchain 41 based on the index DB. The index DB includes a block number range (BlockInfo), and the blockchain network 40 may extract corresponding blockchain data blocks (which may be referred to as “data blocks” or “block data”) from the data blockchain 41 based on the block number range.

Operation S250 is an operation of generating a validation DB.

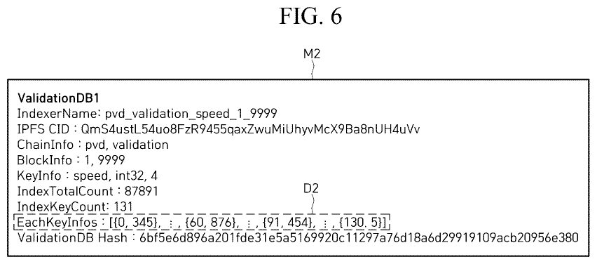

The blockchain network 40 classifies the extracted data blocks based on an index key (a data field) of the index DB in the same manner as the indexing procedure, and counts the number of pieces of data corresponding to each key value to generate key value-data count pairs (see part D2 in FIG. 6). The blockchain network 40 generates a validation DB based on the extracted data blocks and the key value-data count pairs (see FIG. 6).

Operation S260 is an operation of verifying the index DB.

The blockchain network 40 verifies the index DB by comparing the index DB with the validation DB. For example, the blockchain network 40 verifies the index DB by determining whether the individual key value-data count pairs ({key value, data count}, EachKeyInfos) of the index DB and the validation DB match (whether D1 of FIG. 5 matches D2 of FIG. 6).

When no abnormality is found in the verification result of the index DB (for example, when the key value-data count pairs match), operation S270 is performed, and otherwise, operation S280 is performed.

Operation S270 is an operation of storing the index DB in the blockchain.

The blockchain network 40 stores the index DB in a verification blockchain 42, which may be referred to as a validation channel.

Operation S280 is an operation of transmitting verification and index DB storage results to the index manager 120.

The blockchain network 40 transmits the verification result of the index DB to the index manager 120. When there is no abnormality in the index DB, the blockchain network 40 also transmits the index DB storage result to the index manager 120.

Hereinafter, a specific operation process of the index DB generation and verification method is described with reference to FIG. 4.

### 1. Requesting a Block Range

The index manager 120 requests a specific range of block data from the blockchain network 40. This request is performed with a “GetRangeBlock(begin, end)” command. Through this, the index manager 120 may retrieve the required range of block data.

### 2. Inserting an Index

The index manager 120 transmits the block data received from the blockchain network 40 to the indexer 130.
The indexer 130 generates an index by indexing data transmitted through an “InsertIndex(idx1, Blocks)” command.

### 3. Generating a Validation Database

The indexer 130 stores the index in the IPFS 140. This process is performed through a “CreateIndexDB()” command. Data (files) stored in the IPFS 140 is managed through a distributed storage system.

### 4. Returning Verification Results

The data stored in the IPFS is verified by the indexer 130, and the verification result is transmitted to the index manager 120 (“Result(idx1, IndexDB1),” “Result(idx1, IndexDB2),” and “Result(idx1, IndexDB3)”).

### 5. Storing Index Data

The index manager 120 generates metadata based on the indexes stored through each indexer (e.g., 130-1, 130-2, and 130-3), and generates an index DB based on the metadata. The index manager 120 stores the index DB in the blockchain network 40. This process is performed through “PutIndexData(IndexDB1),” “PutIndexData(IndexDB2),” and “PutIndexData(IndexDB3)” commands.

### 6. Verification Process

The blockchain network 40 performs a verification task on the index DB based on the index DB.

### 7. Storing Verified Data

The blockchain network 40 stores the verified index DB in the verification blockchain 42. This process is performed through “PutValidationDB(IndexDB1),” “PutValidationDB(IndexDB2),” and “PutValidationDB(IndexDB3)” commands.

### 8. Return of Verification Results

Finally, the verification blockchain 42 returns the verification results to the index manager 120.

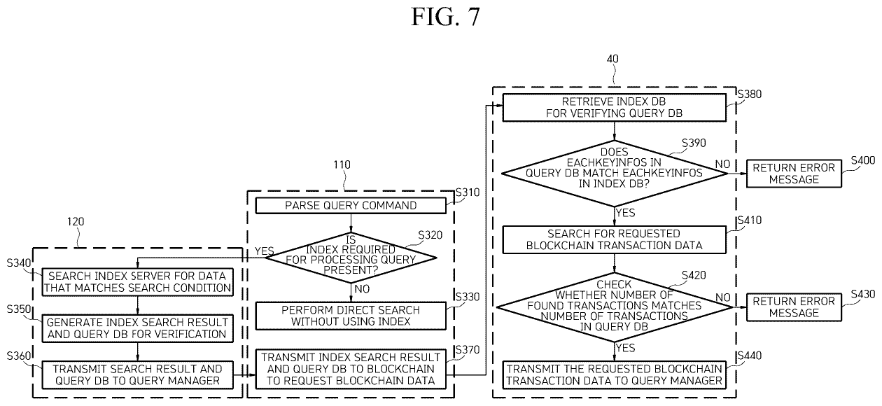

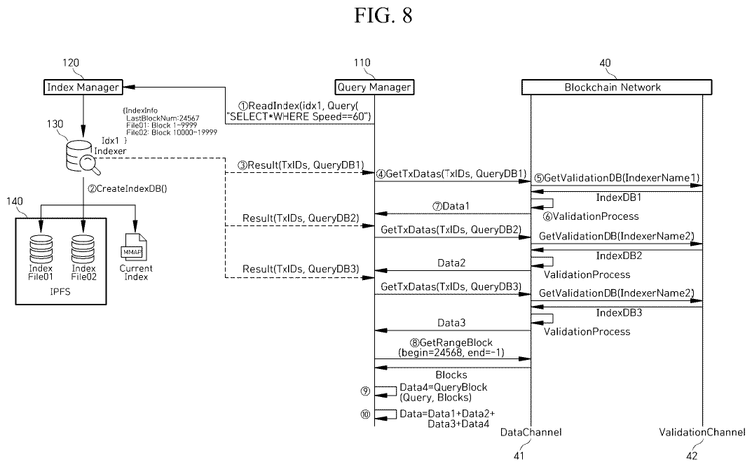

FIGS. 7 and 8 are flowcharts for describing a method of verifying blockchain data query processing results according to an embodiment of the present invention.

In FIGS. 7 and 8, a process in which the system 100, upon receiving a data search request (a query command) for the blockchain network 40 from the user application 20, performs a preliminary search and using the corresponding search result and validation data (a query DB), requests transaction data corresponding to the query from the blockchain network 40 is illustrated.

Referring to FIG. 7, a method of verifying blockchain data query processing results according to an embodiment of the present invention includes operations S310 to S430. The method of verifying blockchain data query processing results shown in FIG. 7 is based on an embodiment, and operations of the method of verifying blockchain data query processing results according to the present invention are not limited to the embodiment shown in FIG. 7, and some operations may be added, changed, or omitted as needed.

When a query command (e.g., a request for transactions with a speed of 60) is transmitted from the user application 20 to the query manager 110, the query manager 110 parses the query command (S310) and determines whether an index required for processing the query is present in the system 100 based on the parsing result of the query command (S320). When the index is not present, the query manager 110 searches for transaction data through the blockchain network 40 in a direct search manner without using an index and transmits the found data to the user application 20 (S330).

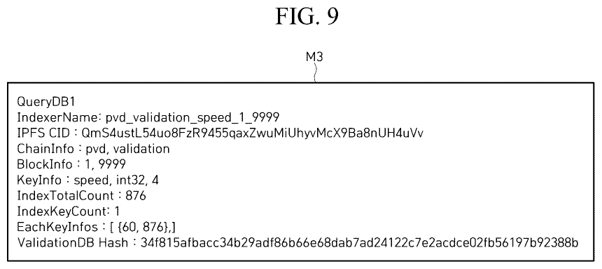

In operation S320, when the index is present, the query manager 110 generates a search condition based on the parsing result and transmits the search condition to the index manager 120, and the index manager 120 transmits the search condition (e.g., a transaction with a speed of 60) to each indexer 130. For example, the index manager 120 transmits a search condition (which may be a query command) to an indexer (a speed indexer 130-a) which is in charge of speed (S340), and the speed indexer 130-a, based on the search condition, generates a transaction list (a query processing result) that is indexed and corresponds to the search condition (e.g., a transaction with a speed of 60) from index files managed by the speed indexer 130-a, and a query DB for individual query verification (see FIG. 9) (S350). The query DB includes the number of transactions with a speed of 60 and the name (IndexerName) of the indexer subject to verification that is stored in the blockchain (see FIG. 9). In other words, the query DB may serve as a data structure for verifying the integrity of the transaction list, which is a query processing result.

The index manager 120 transmits the query processing result (a transaction list generated as an index search result) using the indexer 130 and the query DB to the query manager 110 (S360), and the query manager 110 transmits the query processing result and the query DB to the blockchain network 40 to request transaction data corresponding to the query command (S370).

The blockchain network 40 extracts an index DB for verifying the query DB based on the query DB from the verification blockchain 42 (S380).

The blockchain network 40 checks whether contents (e.g., EachKeyInfos) of the index DB and the query DB match each other (S390), and when the contents do not match, returns an error message to the query manager 110 (S400).

As a result of the verification, when the contents of the index DB and the query DB match, the blockchain network 40 searches for and extracts the transaction data for the transaction list received from the data blockchain 41 (S410).

When the transaction data for all requested transaction lists are normally retrieved (for example, when the number of found transactions matches the number of transactions indicated in the query DB) (S420), the blockchain network 40 transmits blockchain data (the transaction data) to the query manager 110 (S440), and when blockchain data for one or more transactions is missing, determines that the query processing result from the index has been falsified and returns an error message to the query manager 110 (S430).

Hereinafter, a specific operation process of a method of verifying blockchain data query processing results is described with reference to FIG. 8.

### 1. Reading a Query Index (ReadIndex)

The query manager 110 requests a query from the index manager 120 through a “ReadIndex(idx 1, Query(“SELECT*WHERE Speed ==60”))” command. Through this, an index that meets a specific condition is retrieved.

### 2. Generating a Validation Database (CreateQueryDB)

The indexer 130 searches indexed data for data that matches the query condition and generates result data. In this process, a query DB is generated using the “CreateQueryDB()” command.

### 3. Returning Verification Results (Result)

The index manager 120 returns the query processing result and the query DB to the query manager 110. The returned results are delivered in the form of “Result(TxIDs, QueryDB1),” “Result(TxIDs, QueryDB2),” and “Result(TxIDs, QueryDB3).”

### 4. Retrieving Transaction Data (GetTxDatas)

The query manager 110 requests transaction data from the blockchain network 40 through a “GetTxDatas(TxIDs, QueryDB1)” command.

### 5. Retrieving an Index DB (GetValidationDB)

The blockchain network 40 retrieve an index DB IndexDB1, which is an index DB corresponding to IndexerName1, through a “GetValidationDB(IndexerName1)” command. This operation is repeated for IndexerName2 and IndexerName3.

### 6. Verification Process (ValidationProcess)

The blockchain network 40 performs a verification procedure, thereby verifying the integrity of the data. The verification procedure is as follows. QueryDB1 (one of a plurality of query DBs) specifies key values required for verification and the number of transactions corresponding to each key value. The blockchain network 40 analyzes transactions based on the query DB, compares the key values and the number of transactions containing the key values with the corresponding values in IndexDB1 (the index DB) to determine whether the values match. When the values match, the verification is passed. This process may be repeated for other query DBs (QueryDB2 and QueryDB3).

### 7. Returning Transaction Data (Data)

The blockchain network 40 returns the requested transaction data to the query manager 110. The returned data is transmitted in the form of “Data1,” “Data2,” and “Data3.”

### 8. Retrieving Block Range (GetRangeBlock)

The query manager 110 performs an additional query on the latest blockchain data that is not included in an indexer, i.e., data not included in the block number range managed by the current indexer. That is, the query manager 110 requests block data of a specific range (the latest block not provided by the index) from the blockchain network 40 through a “GetRangeBlock(begin=24568, end=−1)” command.

### 9. Query Block Data (QueryBlock)

The query manager 110 executes a query command on the blockchain data obtained in the operation 8 (GetRangeBlock) through a “QueryBlock(Query, Blocks)” command. The result is Data4.

### 10. Final Data Summation (Data)

The query manager 110 sums the final data through a “Data=Data1+Data2+Data3+Data4” command and returns the result to the user application 20.

The method of generating and verifying an index DB and the method of verifying blockchain data query processing results have been described above with reference to the flowcharts presented in the drawings. While the above methods have been shown and described as a series of blocks for the purpose of simplicity, it is to be understood that the present invention is not limited to the order of the blocks, and that some blocks may be executed in a different order from that shown and described herein or executed concurrently with other blocks, and various other branches, flow paths, and sequences of blocks that achieve the same or similar results may be implemented. In addition, not all illustrated blocks are necessarily required for implementation of the method described herein.

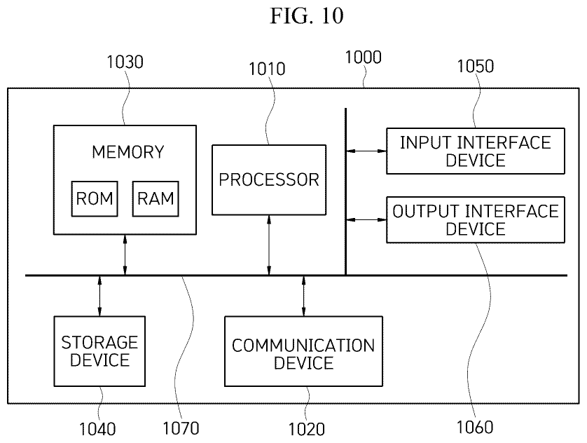

Meanwhile, in the description with reference to FIGS. 3, 4, 7, and 8, each operation may be further divided into a larger number of operations or combined into a smaller number of operations according to examples of implementation of the present invention. In addition, some of the operations may not be performed or the order of operations may be changed as needed. In addition, even in the case of omitted content, the content of FIG. 1 and 2 may be applied to the content of FIGS. 3 to 9. In addition, the content of FIGS. 3 to 9 may be applied to the content of FIGS. 1 and 2, or FIG. 10.

FIG. 10 is a block diagram illustrating a computer system for implementing a method according to an embodiment of the present invention.

Referring to FIG. 10, the computer system 1000 may include at least one of a processor 1010, a memory 1030, an input interface device 1050, an output interface device 1060, and a storage device 1040 that perform communication through a bus 1070. The computer system 1000 may further include a communication device 1020 coupled to a network. The processor 1010 may be a central processing unit (CPU) or a semiconductor device for executing instructions stored in the memory 1030 and/or storage device 1040. The memory 1030 and the storage device 1040 may include various forms of volatile or nonvolatile media. For example, the memory may include a read only memory (ROM) or a random access memory (RAM). In an embodiment of the present invention, the memory may be located inside or outside the processor and may be connected to the processor 1010 through various known means. The memory 1030 may include various forms of volatile or nonvolatile media, for example, may include a ROM or a RAM.

Accordingly, the embodiments of the present invention may be embodied as a method implemented by a computer or as non-transitory computer readable media in which computer executable instructions are stored. According to an embodiment, when executed by a processor 1010, computer readable instructions may perform a method according to at least one aspect of the present disclosure.

The communication device 1020 may transmit or receive a wired signal or a wireless signal.

In addition, the method according to the present invention may be implemented in the form of program instructions executable by various computer devices and may be recorded on computer readable media.

The computer readable media may be provided with program instructions, data files, data structures, and the like alone or in combination. The program instructions recorded on the computer readable media may be specially designed and constructed for the purposes of the present invention or may be well known and available to those skilled in the art of computer software. The computer readable storage media include hardware devices configured to store and execute program instructions. For example, the computer readable storage media include magnetic media such as hard disks, floppy disks, and magnetic tape, optical media such as a CD-ROM and a DVD, magneto-optical media such as floptical disks, a ROM, a RAM, a flash memory, etc. The program instructions include not only machine language code made by a compiler but also high level code that may be used by an interpreter etc., which is executed by a computer.

The processor 1010 may execute the instructions stored in the memory 1030 or the storage device 1040 to collect block data in a predetermined range from a blockchain network 40, index the block data to generate an index; generate an index DB, which is a data structure for verifying integrity of the index, based on the index, and transmit the index DB to the blockchain network 40.

The processor 1010 may be configured to, upon receiving a query command from a user application 20, parse the query command and generate a search condition based on a parsing result for the query command, generate a transaction list corresponding to the search condition and a query DB which is a data structure for verifying the transaction list, and transmit the transaction list and the query DB to the blockchain network 40 to request transaction data corresponding to the query command from the blockchain network 40.

The processor 1010 may be configured to allow the blockchain network 40 to verify the query DB based on the query DB and the index DB, and when determined, as a result of verification of the query DB, that there is no abnormality, receive the transaction data from the blockchain network 40.

Even in the case of omitted content in FIG. 10, the content of FIGS. 1 to 9 may be applied to the content of FIG. 10.

Data search on a blockchain platform is performable using an index provided by the platform itself or by replicating blockchain data to an external database.

When using the index provided by the platform itself, searches are performed with values required for blockchain configuration (a block number, a transaction ID), and other search queries require sequentially reading the blocks of the blockchain platform from the beginning and comparing the read blocks, resulting in low efficiency.

Data search services are also provided by replicating blockchain data to an external database, but in this case, the benefits of a blockchain platform in which data manipulation, change, and deletion are impossible can be lost.

In the present invention, a validation database for a blockchain data index is generated for data search, the validation database is verified and stored on a blockchain platform, and a verification task on query results using the index is performed in a query processing operation using the validation database stored on the blockchain platform, thereby ensuring the integrity and reliability of the query results of the blockchain data index stored externally.

The effects of the present invention are not limited to those described above, and other effects that are not described above will be clearly understood by those skilled in the art from the above detailed description.

Although the present invention has been described in detail above with reference to exemplary embodiments, those of ordinary skill in the technical field to which the present invention pertains should be able to understand that various modifications and alterations may be made without departing from the technical spirit and scope of the present invention.

What is claimed is:

1. A method of managing a blockchain data index and verifying a query processing result, the method comprising:
collecting, by a system for managing a blockchain data index and verifying a query, block data in a predetermined range from a blockchain network;
indexing, by the system, the block data to generate an index;
generating, by the system, an index database (DB), which is a data structure for verifying integrity of the index, based on the index; and
transmitting, by the system, the index DB to the blockchain network to request verification.

2. The method of claim 1, further comprising:
generating, by the blockchain network, a validation DB for verifying the index DB based on the index DB; and
verifying, by the blockchain network, the index DB by comparing the index DB with the validation DB.

3. The method of claim 2, further comprising storing, by the blockchain network, the index DB in a verification blockchain when no abnormality is found as a result of the verifying of the index DB.

4. The method of claim 2, wherein the verifying of the index DB includes comparing, by the blockchain network, a data count for individual key values included in the index DB with a data count for individual key values included in the validation DB and verifying the index DB.

5. The method of claim 2, further comprising transmitting, by the blockchain network, a result of the verifying of the index DB and a storage result of the index DB to the system when no abnormality is found as a result of the verifying of the index DB.

6. The method of claim 2, further comprising transmitting, by the blockchain network, a result of the verifying of the index DB to the system without storing the index DB in a verification block chain when an abnormality is found as a result of the verifying of the index DB.

7. The method of claim 1, wherein the index DB includes information including a range of block numbers corresponding to the predetermined range, a name of an indexer managing the index within the system, a key value included in the index, and a pair of the key value and a data count for the key value.

8. The method of claim 3, further comprising:
receiving, by the system, a query command from a user application;
parsing, by the system, the query command and generating a search condition based on a parsing result for the query command;
generating, by the system, a transaction list corresponding to the search condition and a query DB which is a data structure for verifying the transaction list; and
transmitting, by the system, the transaction list and the query DB to the blockchain network to request transaction data corresponding to the query command.

9. The method of claim 8, further comprising comparing, by the blockchain network, the query DB with the index DB and verifying the query DB.

10. The method of claim 9, further comprising, when it is determined, as a result of the verifying of the query DB by the blockchain network, that there is no abnormality,
receiving, by the system, the transaction data corresponding to the transaction list from the blockchain network.

11. The method of claim 9, wherein the verifying of the query DB includes comparing, by the blockchain network, a data count for individual key values included in the query DB with a data count for individual key values included in the index DB and verifying the query DB.

12. The method of claim 9, wherein the verifying of the query DB includes:
comparing, by the blockchain network, a data count for individual key values included in the query DB with a data count for individual key values included in the index DB;
when the data counts for the individual key values match each other, extracting the transaction data corresponding to the transaction list from the data blockchain; and
determining whether the number of transactions included in the query DB and the number of transactions of the transaction data extracted from the data blockchain match each other and verifying the query DB.

13. A method of managing a blockchain data index and verifying a query processing result, the method comprising:
receiving, by a system for managing a blockchain data index and verifying a query processing result, a query command from a user application;
parsing, by the system, the query command and generating a search condition based on a parsing result for the query command;
generating, by the system, a transaction list corresponding to the search condition and a query DB which is a data structure for verifying the transaction list; and
transmitting, by the system, the transaction list and the query DB to a blockchain network to request transaction data corresponding to the query command.

14. The method of claim 13, further comprising comparing, by the blockchain network, the query DB with an index DB that includes information about an index managed by the system and verifying the query DB.

15. The method of claim 14, further comprising, when it is determined, as a result of the verifying of the query DB by the blockchain network, that there is no abnormality,
receiving, by the system, the transaction data corresponding to the transaction list from the blockchain network.

16. The method of claim 14, wherein the verifying of the query DB includes comparing, by the blockchain network, a data count for individual key values included in the query DB with a data count for individual key values included in the index DB and verifying the query DB.

17. The method of claim 14, wherein the verifying of the query DB includes:
comparing, by the blockchain network, a data count for individual key values included in the query DB with a data count for individual key values included in the index DB;
when the data counts for the individual key values match each other, extracting the transaction data corresponding to the transaction list from the data blockchain; and
determining whether the number of transactions included in the query DB and the number of transactions of the transaction data extracted from the data blockchain match each other and verifying the query DB.

18. A system for managing a blockchain data index and verifying a query processing result, the system comprising:
a memory storing computer-readable instructions; and
at least one processor configured to execute the instructions,
wherein the at least one processor executes the instructions to:
collect block data in a predetermined range from a blockchain network;
index the block data to generate an index;
generate an index DB which is a data structure for verifying integrity of the index, based on the index; and
transmit the index DB to the blockchain network.

19. The system of claim 18, wherein the at least one processor is configured to:
upon receiving a query command from a user application, parse the query command and generate a search condition based on a parsing result for the query command;
generate a transaction list corresponding to the search condition and a query DB which is a data structure for verifying the transaction list; and
transmit the transaction list and the query DB to the blockchain network to request transaction data corresponding to the query command.

20. The system of claim 19, wherein the at least one processor is configured to:
allow the blockchain network to verify the query DB based on the query DB and the index DB; and
when it is determined, as a result of the verifying of the query DB, that there is no abnormality, receive the transaction data from the blockchain network.
